(19) United States
(12) Patent Application Publication
(10) Pub. No.: US 2026/0331319 A1
(43) Pub. Date: Oct. 22, 2026

(54) METHOD FOR MANUFACTURE OF COATED URANIUM-BEARING FUEL PARTICLES FOR ULTRA-HIGH TEMPERATURE ENERGY APPLICATIONS

(71) Applicant: Standard Nuclear, Inc., Oak RIdge, TN (US)

(72) Inventors: Kurt A. TERRANI, Knoxville, TN (US); Michael P. Trammell, Andersonville, TN (US); Brian C. Jolly, Heiskell, TN (US)

(73) Assignee: Standard Nuclear, Inc., Oak Ridge, TN (US)

(21) Appl. No.: 19/192,798

(22) Filed: Apr. 29, 2025

Related U.S. Application Data
(60) Provisional application No. 63/639,908, filed on Apr. 29, 2024.

(51) Int. Cl. G21C 21/02; G21C 3/04; G21C 3/07; G21C 3/20; G21C 3/28; G21C 3/62

(52) U.S. Cl. CPC G21C 21/02; G21C 3/07; G21C 3/20; G21C 3/28; G21C 3/626; G21C 3/048

(57) ABSTRACT

A method includes forming a uranium carbide kernel; depositing a protective carbon layer onto the uranium carbide kernel; depositing an inner zirconium carbide layer onto the protective carbon layer; and depositing one or more coating layers around the inner zirconium carbide layer to fabricate an interim fuel particle. The interim fuel particle can include a carbon buffer layer, an inner pyrolytic carbon layer, a zirconium carbide coating layer, and an optional outer pyrolytic carbon layer around the inner zirconium carbide layer. The method further includes applying a high temperature heat treatment to the interim fuel particle to form a final fuel particle comprising a uranium zirconium carbide fuel kernel and the one or more coating layers. The final fuel particle can include the uranium zirconium carbide fuel kernel, the carbon buffer layer, the inner pyrolytic carbon layer, the zirconium carbide coating layer, and the optional outer pyrolytic carbon layer.

### CROSS-REFERENCE TO RELATED APPLICATIONS

This application claims priority to U.S. Provisional Patent Application No. 63/639,908, filed on Apr. 29, 2024, titled “Method for Manufacture of Coated Uranium-Bearing Fuel Particles for Ultra-High Temperature Energy Applications,” the entire disclosure of which is incorporated by reference herein.

### TECHNICAL FIELD

The present subject matter relates to the manufacture of a coated nuclear fuel particle capable of withstanding ultra-high temperatures. The present subject matter relates to an efficient method for manufacture of an advanced coated uranium-bearing nuclear fuel particle that may be produced at temperatures well below the application temperature of the nuclear fuel. The present subject matter also relates to nuclear fuel that can be used in a nuclear thermal propulsion (NTP) engine, for example, to power a space vehicle.

### BACKGROUND

NTP was initially developed for use in launch vehicles primarily—advanced rockets where hydrogen is heated to ultra-high temperatures (approximately 3000 K) and discharged at the rocket exhaust, in turn propelling the rocket. Therefore, the nuclear fuel in the NTP engine should be able to withstand such ultra-high temperatures. In addition, NTP can be used in other applications, such as the propulsion of submarines or ships.

Multi-constituent carbides are known to exhibit ultra-high temperature melting points. Ternary carbides are amongst this group of materials and when dissolved and mixed together they exhibit an increased melting point compared to their individual monocarbide forms. Uranium carbide (UC) is a nuclear fuel material with a long history of application in nuclear energy. However, the melting point of UC is approximately 2700±25 K and UC2 is approximately 2720 K, limiting their application to below these temperatures. Instead, if a mixture of UC and zirconium carbide (ZrC) is used, the melting point of the resulting U—Zr—C solid solution may be increased to well above 3000 K. Temperatures at and in excess of 3000 K are essential for a select set of nuclear energy applications, such as those for NTP.

U—Zr—C solid solution fuel forms have been long time candidates for NTP applications. Their method of manufacture was previously carried out via a powder processing route either to make the compound powder feedstock or as fine irregular particles dispersed inside a graphite fuel element. However, the solid solution fuel systems did not benefit from discrete protective coatings (the larger graphite elements were often coated with ZrC) and were susceptible to corrosion/erosion once the fuel elements were exposed to hot hydrogen. This issue was addressed in U.S. Pat. No. 11,189,383, issued Nov. 30, 2021, titled “Processing Ultra High Temperature Zirconium Carbide Microencapsulated Nuclear Fuel,” the entirety of which is incorporated by reference herein, where use of discrete coated fuel particles and their dispersion inside a ZrC matrix was proposed. However, there remains a need for the method to manufacture said coated fuel particles with ultra-high temperature capability (e.g., no or limited melting at temperatures up to 3000 K).

### SUMMARY

To manufacture coated fuel particles with ultra-high temperature capability there are two possible approaches. The first approach is to manufacture a U—Zr—C microsphere. The second approach is to process the U—Zr—C in-situ during the remaining manufacturing steps or in-situ during the actual fuel application. For the first approach, a number of options, such as solution-gelation and conversion are possible, though they require very high temperature processing for the production of the U—Zr—C microsphere prior to any coating. The focus of the examples described herein are to provide a detailed description of processes for production of fuel particles with ultra-high temperature capability via the second approach.

The methods 400A-B described herein deliver a solution for manufacturing of coated uranium-bearing nuclear fuel particles for ultra-high temperature energy applications. The methods involve manufacturing at temperatures far below the application temperature. The final state of the coated fuel particle may be achieved via a heat treatment prior to the final application or during the application itself.

In a first example, a method 400A includes forming a uranium carbide kernel 101. The method 400A further includes depositing a protective carbon layer 102 onto the uranium carbide kernel 101. The method 400A further includes depositing an inner zirconium carbide layer 103 onto the protective carbon layer 102. The method 400A further includes depositing one or more coating layers 104-107 around the inner zirconium carbide layer 103 to fabricate an interim fuel particle 100. The method 400A further includes applying a high temperature heat treatment to the interim fuel particle 100 to form a final fuel particle 200 comprising a uranium zirconium carbide fuel kernel 201 and the one or more coating layers 104-107.

In a second example, a method 400B includes forming a uranium carbide kernel 101. The method 400B further includes depositing a protective carbon layer 102 onto the uranium carbide kernel 101. The method 400B further includes depositing an inner zirconium carbide layer 103 onto the protective carbon layer 102. The method 400B further includes depositing a carbon buffer layer 104, an inner pyrolytic carbon layer 105, a zirconium carbide coating layer 106, and an outer pyrolytic carbon layer 107 around the inner zirconium carbide layer 103 to fabricate an interim fuel particle 100. The method 400B further includes applying a high temperature heat treatment to the interim fuel particle 100 to form a final fuel particle 200 comprising a uranium zirconium carbide fuel kernel 201, the carbon buffer layer 104, the inner pyrolytic carbon layer 105, the zirconium carbide coating layer 106, and the outer pyrolytic carbon layer 107.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities, and combinations particularly pointed out in the appended claims.

### BRIEF DESCRIPTION OF THE DRAWINGS

The drawing figures depict one or more implementations, by way of example only, not by way of limitations. In the figures, like reference numerals refer to the same or similar elements.

FIG. 1 is a cross-sectional view of an interim fuel particle showing a uranium carbide (U—C) fuel kernel and individual coating layers prior to a high temperature heat treatment.

FIG. 2 is a cross-sectional view of a final fuel particle after the high temperature heat treatment showing a uranium zirconium carbide (U—Zr—C) fuel kernel and individual coating layers.

FIG. 3 is an isometric view of the interim fuel particle of FIG. 1 showing the uranium carbide kernel, a protective carbon layer, an inner zirconium carbide layer, and one or more coating layers prior to the high temperature heat treatment.

FIGS. 4A-B are flowcharts of methods of manufacturing.

FIG. 5A is an isometric view of a fuel compact that includes a plurality of interim fuel particles.

FIG. 5B is a cutaway view of the fuel compact of FIG. 5A showing details of the plurality of interim fuel particles embedded inside an encapsulation matrix.

### PARTS LISTING

100 Interim Fuel Particle
100A-N Interim Fuel Particles
101 Uranium Carbide Kernel
102 Protective Carbon Layer
103 Inner Zirconium Carbide Layer
104-107 One or More Coating Layers
104 Carbon Buffer Layer
105 Inner Pyrolytic Carbon Layer
106 Binary Carbide Layer (e.g., Zirconium Carbide Coating Layer)
107 Outer Pyrolytic Carbon Layer
200 Final Fuel Particle
200A-N Final Fuel Particles
201 Uranium Zirconium Carbide Fuel Kernel
400A-B Methods
500 Fuel Compact
505 Encapsulation Matrix

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The term “coupled” as used herein refers to any logical, physical, or electrical connection. Unless described otherwise, coupled elements or devices are not necessarily directly connected to one another and may be separated by intermediate components, elements, etc.

The orientations of the interim fuel particles 100A-N, final fuel particles 200AN, fuel compact 500, and/or any nuclear reactor system incorporating interim fuel particles 100A-N, final fuel particles 200A-N or fuel compact 500, such as shown in any of the drawings, are given by way of example only, for illustration and discussion purposes. In operation for a particular nuclear reactor system, the components may be oriented in any other direction suitable to the particular application of the nuclear reactor system, for example upright, sideways, or any other orientation. Also, to the extent used herein, any directional term, such as lateral, longitudinal, up, down, upper, lower, top, bottom, and side, are used by way of example only, and are not limiting as to direction or orientation of any nuclear reactor system or component of the nuclear reactor system constructed as otherwise described herein. Reference now is made in detail to the examples illustrated in the accompanying drawings and discussed below.

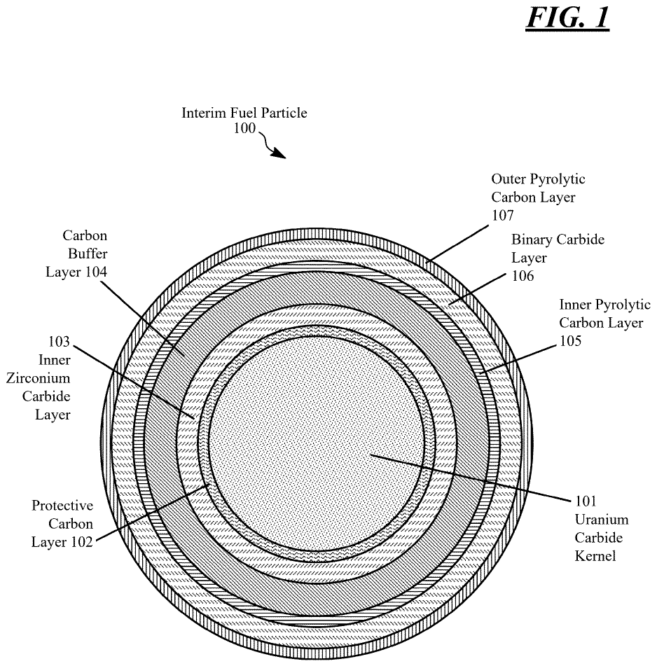

Unless otherwise indicated, any embodiment can be combined with any other embodiment. In particular, FIGS. 1-5B and the associated text are all combinable with each other. Reference now is made in detail to the examples illustrated in the accompanying drawings and discussed below.

FIG. 1 is a cross-sectional view of an interim fuel particle 100 showing a uranium carbide (U—C) fuel kernel 101 and individual coating layers 102-107 prior to a high temperature heat treatment. The individual coating layers 102-107 can be sequential and successively surround the uranium carbide kernel 101. As shown, the interim fuel particle 100 includes a uranium carbide kernel 101 surrounded by a protective carbon layer 102, an inner zirconium carbide layer 103, and one or more coating layers 104-107. In the example, the one or more coating layers 104-107 include a carbon buffer layer 104, an inner pyrolytic carbon layer 105, a binary carbide layer (e.g., zirconium carbide coating layer) 106, and an outer pyrolytic carbon layer 107.

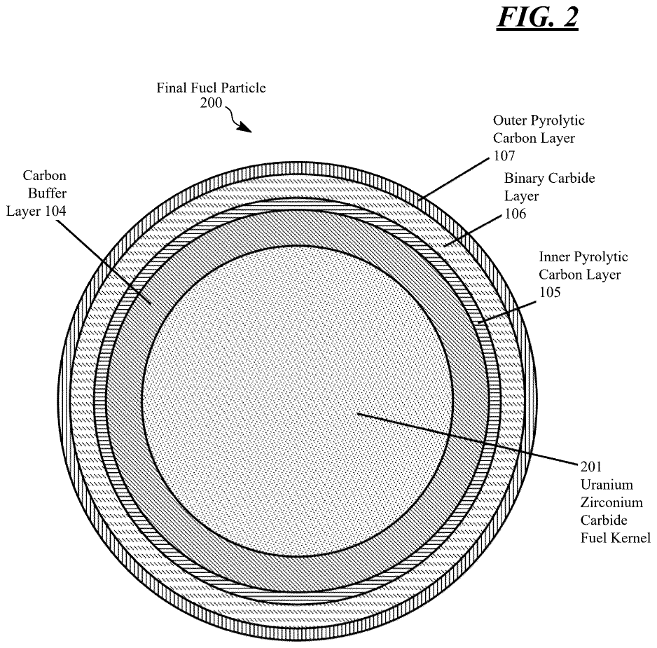

FIG. 2 is a cross-sectional view of a final fuel particle 200 after the high temperature heat treatment showing a uranium zirconium carbide (U—Zr—C) fuel kernel 201 and individual coating layers 104-107. As shown, the final fuel particle 200 comprises a uranium zirconium carbide fuel kernel 201 and the one or more coating layers 104-107. In the example, the final fuel particle 200 is comprised of the uranium zirconium carbide fuel kernel 201, the carbon buffer layer 104, the inner pyrolytic carbon layer 105, the binary carbide layer (e.g., zirconium carbide coating layer) 106, and the outer pyrolytic carbon layer 107. The one or more coating layers 104-107 can be sequential and successively surround the uranium zirconium carbide fuel kernel 201.

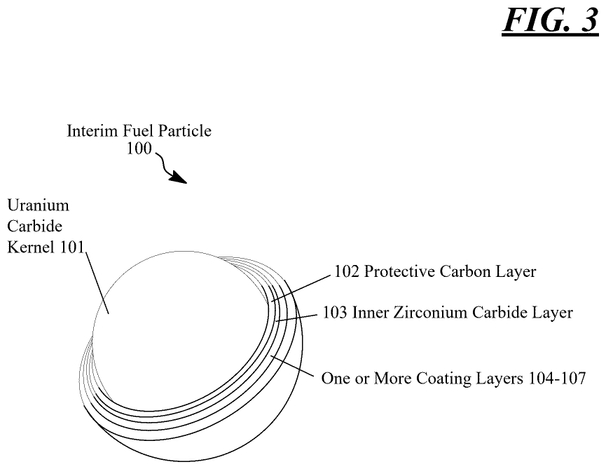

FIG. 3 is an isometric view of the interim fuel particle 100 of FIG. 1 showing the uranium carbide kernel 101, the protective carbon layer 102, the inner zirconium carbide layer 103, and one or more coating layers 104-107 prior to the high temperature heat treatment.

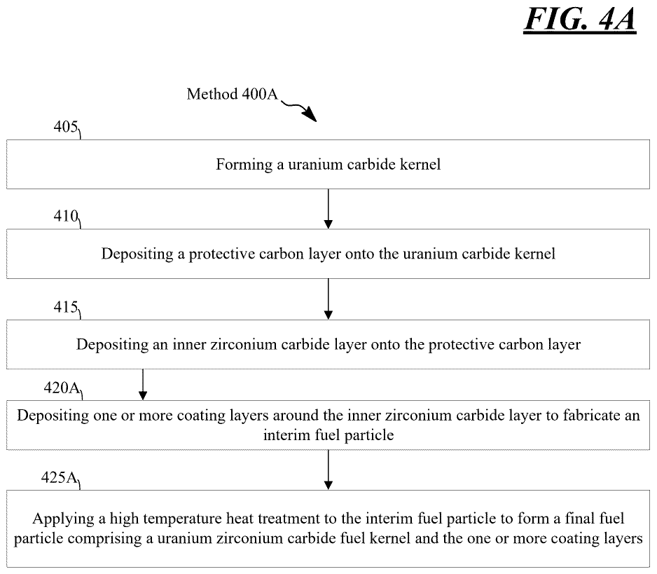

FIGS. 4A-B are flowcharts of methods 400A-B of manufacturing. Generally, the manufacturing methods 400A-B comprise several steps and different technologies that can include chemical vapor infiltration (CVI), chemical vapor deposition (CVD), fuel particles 100A-N, 200A-N (e.g., particle-based nuclear fuel), and additive manufacturing. The methods 400A-B describe a detailed step-by-step methodology for the manufacture of an ultra-high temperature capable coated nuclear fuel particle. The methods 400A-B can involve manufacture of a uranium-bearing microsphere and coating it with a successive layer of carbon and carbide ceramics at temperatures well below its intended application temperature to power a nuclear thermal propulsion (NTP) engine or a nuclear reactor. Once manufactured, the interim fuel particles 100A-N may be heated to ultra-high temperatures prior to or at the onset of the application upon which the inner coating layers 102-103 will react with the uranium carbide kernel 101, in situ, to realize a ternary uranium zirconium carbide fuel kernel 201 capable of withstanding those temperatures.

With reference to FIG. 4A, beginning in step 405, the method 400A of FIG. 4A includes forming a uranium carbide kernel 101. For the kernel manufacturing step 405, proven sol-gel methods can be used to produce a uranium monocarbide fuel kernel 101. This is highly advantageous compared to a process that aims to produce a uranium-and zirconium-bearing gel sphere with added carbon. Both uranium and zirconium dissolve in nitric acid and the latter may need to also be precipitated/gelled or added in a different chemical form. The gelation process is highly complex and simultaneous interaction of dissolved uranium and zirconium ions with the organics and carbon in the broth may need to be carefully managed. In the example, once uranium carbide kernels 101A-N are manufactured starting from air dried uranium-bearing gel spheres that have undergone calcination, conversion and densification, it is possible to proceed to the next step of the method 400A.

Continuing to step 410, the method 400A further includes depositing a protective carbon layer 102 onto the uranium carbide kernel 101. The protective carbon layer 102 can be deposited at a temperature of approximately 1200 Celsius. The deposition conditions for this step 410 can be carefully managed as there exists a driving force for UC to react with excess carbon and produce UC2. The rate of carbon diffusion in UC has been quantified and through the careful selection of the temperature and duration of the deposition, a protective carbon layer 102 may be deposited on top of UC without being consumed by the UC substrate (e.g., the rate of deposition is faster than the rate of carbon consumption by the UC substrate). The chemical precursors and deposition conditions can be chosen such that a high-density and gas-impermeable carbon coating is deposited so that it protects the uranium carbide kernel 101 from chemical attack during the next step 415. The thickness of this protective carbon layer 102 can influence the kernel composition in the future.

Proceeding to step 415, the method 400A further includes depositing an inner zirconium carbide layer 103 onto the protective carbon layer 102. The inner zirconium carbide layer 103 can be deposited at a temperature between approximately 1200 to 1500 Celsius. In step 415, a fluidized bed chemical vapor deposition (FBCVD) process can be used to deposit the inner zirconium carbide layer 103 onto the uranium carbide kernel 101 which has the protective carbon layer 102 applied. Deposition of zirconium carbide involves reacting two gaseous precursors to produce zirconium carbide (e.g., zirconium tetrachloride and methane). The byproduct of this process is often corrosive halides (e.g., hydrochloric acid) that will readily corrode uranium compounds. This is why a protective carbon layer 102 can be needed in the previous step 410. The thickness of the inner zirconium carbide layer 103 can be relevant as it will control the final kernel composition. In a first example, the inner zirconium carbide layer 103 is at least one and a half times thicker than the protective carbon layer 102. In a second example, the inner zirconium carbide layer 103 is at least twice as thick as the protective carbon layer 102. In a third example, the inner zirconium carbide layer 103 is at least three times thicker than the protective carbon layer 102. In a fourth example, the inner zirconium carbide layer 103 is at least four times thicker than the protective carbon layer 102. The purpose of the inner zirconium carbide layer 103 is to react, at ultra-high temperatures, with the uranium carbide kernel 101 and produce a uranium zirconium carbide fuel kernel 201 in the final fuel particle 200.

Moving to step 420A, the method 400A further includes depositing one or more coating layers 104-107 around the inner zirconium carbide layer 103 to fabricate an interim fuel particle 100. The last coating layers 104-107 deposited in the manufacturing method 400A can involve multiple deposition steps to produce the typical TRISO coating layers, such as a carbon buffer layer 104, an inner pyrolytic carbon layer 105, a binary carbide layer 106 (e.g., a zirconium carbide coating layer), and an outer pyrolytic carbon layer 107. The outer pyrolytic carbon layer 107 is optional. These processes have been demonstrated in prior art and are being carried out commercially.

The one or more coating layers 104-107 can be formed of pyrolytic carbon (PyC), silicon carbide (SiC), zirconium carbide (ZrC), zirconium diboride (ZrB₂), niobium carbide (NbC), titanium carbide (TiC), tantalum carbide (TaC), titanium nitride (TiN), boron carbide (B₄C), beta-decayed silicon nitride (β-Si₃N₄), SiAlON ceramics, or any combination thereof. The one or more coating layers 104-107 can include a carbon buffer layer 104, an inner pyrolytic carbon layer 105, a binary carbide layer 106, and an optional outer pyrolytic carbon layer 107 around the inner zirconium carbide layer 103. The binary carbide layer 106 can include a refractory metal carbide layer or a ceramic layer. The refractory metal carbide layer can include at least one of titanium carbide (TiC), zirconium carbide (ZrC), niobium carbide (NbC), tantalum carbide, hafnium carbide, ZrC—ZrB₂ composite, ZrC—ZrB₂—SiC composite, or a combination thereof. The refractory metal carbide layer can include zirconium carbide (ZrC). The ceramic layer can include silicon carbide. For ultra-high temperature applications of the final fuel particle 200, zirconium carbide may be preferred as the binary carbide layer 106 because silicon carbide can dissolve (e.g., evaporate) at high operating temperatures, such as in NTP applications.

The precise dimensions and arrangement of the uranium carbide fuel kernel 101, protective carbon layer 102, inner zirconium carbide layer 103, and one or more layers 104-107 can be variable to achieve criticality for a given nuclear design goal and design of the nuclear reactor.

Finishing now in step 425A, the method 400A further includes applying a high temperature heat treatment to the interim fuel particle 100 to form a final fuel particle 200 comprising a uranium zirconium carbide fuel kernel 201 and the one or more coating layers 104-107. In step 425A, after the final coating layers 104-107 are deposited, the interim fuel particle 100 can undergo an in situ transformation once it is exposed to ultra-high temperatures (>2200 Kelvin). While none of the manufacturing temperatures up to this point typically reach this value, once these temperatures are exceeded (either in a pre-application heat treatment step or during the application itself), the reaction between the uranium carbide kernel 101, protective carbon layer 102, and inner zirconium carbide layer 103 takes place and produces a uranium zirconium carbide fuel kernel 201. The uranium zirconium carbide fuel kernel 201 can be spherical shaped. The uranium zirconium carbide fuel kernel 201 is contained within the final fuel particle 200, which includes the one or more coating layers 104-107, such as coating layers of a TRISO fuel particle.

The reaction to create the uranium zirconium carbide fuel kernel 201 can start at approximately 2400 Celsius or approximately 3,000 Kelvin. Prior to application of the high temperature heat treatment, all of the processing steps are at much lower temperatures. In a first example, the high temperature heat treatment can be a temperature of approximately 2,500 Kelvin or above. In a second example, the high temperature heat treatment can be a temperature of approximately 2,700 Kelvin or above. In a third example, the high temperature heat treatment can be a temperature of approximately 3,000 Kelvin or above. The high temperature heat treatment can be applied to the interim fuel particle 100 prior to deployment in a nuclear thermal propulsion (NTP) engine or a nuclear reactor. The high temperature heat treatment can be applied in-situ to the interim fuel particle 100 during operation of a nuclear thermal propulsion (NTP) engine or a nuclear reactor. The final fuel particle 200 can be a tristructural-isotropic (TRISO) fuel particle, a bistructural-isotropic (BISO) fuel particle, or a TRIZO fuel particle. A description of TRISO, BISO, or TRIZO fuel particles dispersed in a zirconium carbide matrix to form a cylindrical shaped nuclear fuel compact is provided in U.S. Pat. No. 11,189,383, issued Nov. 30, 2021, titled “Processing Ultra High Temperature Zirconium Carbide Microencapsulated Nuclear Fuel,” the entirety of which is incorporated by reference herein.

In the examples herein, the interim fuel particles 100A-N are coated fuel particles, such as tristructural-isotropic (TRISO) fuel particles. Alternatively or additionally, the interim fuel particles 100A-N can include bistructural-isotropic (BISO) fuel particles. In yet another implementation, the interim fuel particles 100A-N are comprised of a variation of TRISO known as TRIZO fuel particles. A TRIZO fuel particle replaces the silicon carbide layers of the TRISO fuel particle with zirconium carbide (ZrC). Alternatively, the TRIZO fuel particle includes the typical coatings of a TRISO fuel particle and an additional thin ZrC layer coating around the fuel kernel, which is then surrounded by the typical coatings of the TRISO fuel particle.

TRISO-like coatings may be simplified or eliminated depending on safety implications and manufacturing feasibility. Although the interim fuel particles 100A-N in the example include coated fuel particles, such as TRISO fuel particles, BISO fuel particles, or TRIZO fuel particles, the interim fuel particles 100A-N can include uncoated fuel particles.

With reference to FIG. 4B, steps 405, 410, and 415 of method 400B are identical to those described in FIG. 4A with reference to method 400A; and steps 420B and 425B are very similar to steps 420A and 425A. However, step 420B includes depositing a carbon buffer layer 104, an inner pyrolytic carbon layer 105, a zirconium carbide coating layer 106, and an outer pyrolytic carbon layer 107 around the inner zirconium carbide layer 103 to fabricate an interim fuel particle 100. In addition, step 425B includes applying a high temperature heat treatment to the interim fuel particle 100 to form a final fuel particle 200 comprising a uranium zirconium carbide fuel kernel 201, the carbon buffer layer 104, the inner pyrolytic carbon layer 105, the zirconium carbide coating layer 106, and the outer pyrolytic carbon layer 107. As noted above, the outer pyrolytic carbon layer 107 is optional.

Methods 400A-B provide an efficient method for manufacture of coated uranium-bearing fuel particles for ultra-high temperature energy applications. The methods 400A-B involve and exploit a series of low temperature processing steps to produce and result in an ultra-high temperature fuel particle. With the methods 400A-B, prior art is used to manufacture a uranium carbide kernel 101—a spherical particle of uranium carbide. The methods 400A-B further include depositing a protective carbon layer 102 onto the uranium carbide kernel 101. The methods 400A-B further include depositing an inner zirconium carbide layer 103 onto the protective carbon layer 102. With the methods 400A-B, prior art can then be used to deposit conventional tristructural isotropic coating layers (e.g., a carbon buffer layer 104, an inner pyrolytic carbon layer 105, a binary carbide layer 106, and an outer pyrolytic layer 107) onto the inner zirconium carbide layer 103.

Methods 400A-B further include heating the interim fuel particles 100A-N to ultra-high temperatures prior to or at the onset of NTP application upon which the uranium carbide kernel 101, the protective carbon layer 102, and the inner zirconium carbide layer 103 react, and an ultra-high temperature capable coated uranium zirconium carbide (U—Zr—C) fuel kernel 201 is achieved.

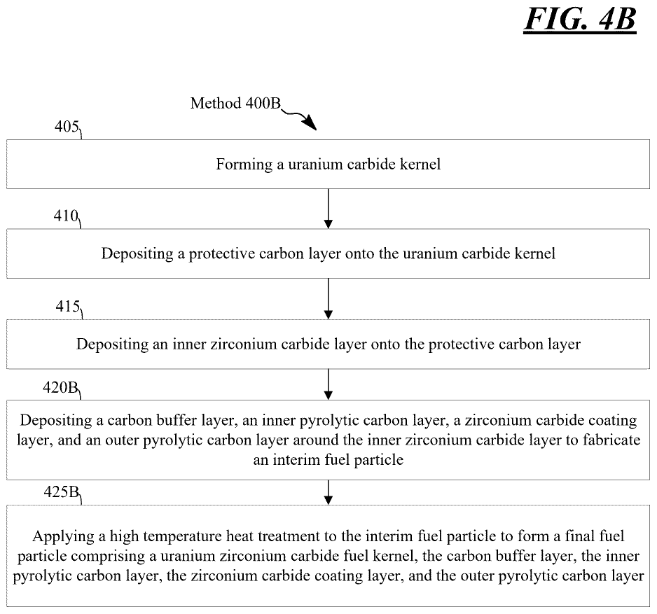

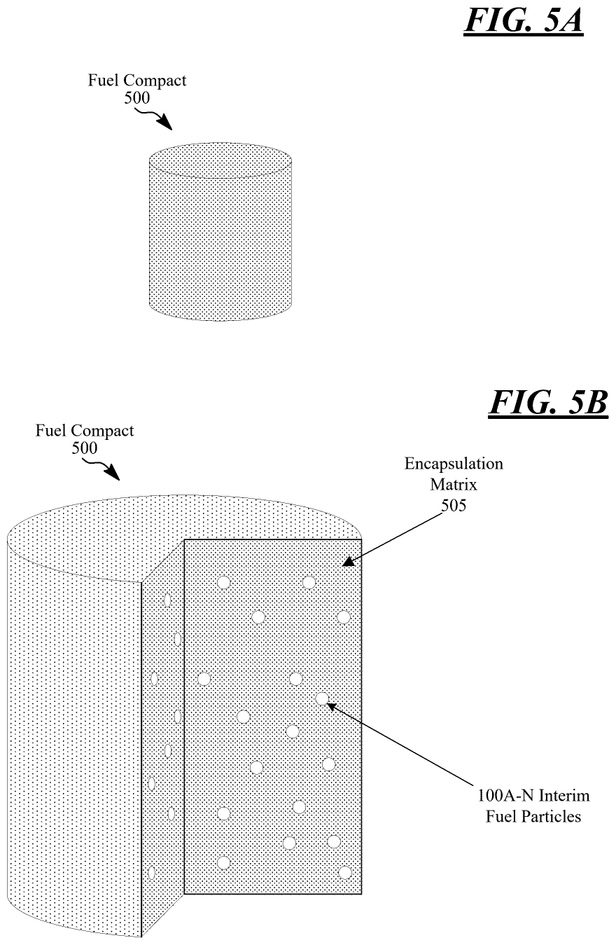

FIG. 5A is an isometric view of a fuel compact 500 that includes a plurality of interim fuel particles 100A-B. FIG. 5B is a cutaway view of the fuel compact 500 of FIG. 5A showing details of the plurality of interim fuel particles 100A embedded inside an encapsulation matrix 505. The methods 400A-B of FIGS. 4A-B can further include disposing a plurality of interim fuel particles 100A-B inside an encapsulation matrix 505 prior to the step 425A-B of applying the high temperature heat treatment.

In method 400A, the step of applying the high temperature heat treatment 425A can be applied to the plurality of interim fuel particles 100A-N inside the encapsulation matrix 505 to form a plurality of final fuel particles 200A-N comprising the uranium zirconium carbide fuel kernel 201 and the one or more coating layers 104-107 inside the encapsulation matrix 505. In method 400B, the step 425B of applying the high temperature heat treatment can be applied to the plurality of interim fuel particles 100A-N inside the encapsulation matrix 505 to form a plurality of final fuel particles 200A-N comprising the uranium zirconium carbide fuel kernel 201 and the carbon buffer layer 104, the inner pyrolytic carbon layer 105, the zirconium carbide coating layer 106, and the outer pyrolytic carbon layer 107 inside the encapsulation matrix 505.

Interim fuel particles 100A-N can be similar in size or of substantially the same size. Alternatively, the interim fuel particles 100A-N can be of varying particle sizes to improve a packing fraction in the fuel compact 500. In some examples, the interim fuel particles 100A-N can be between approximately 100 and 2,000 microns, with multiple size populations (e.g., 100 microns, 700 microns, 2,000 microns, etc.) to enhance the packing fraction of fuel particles 151A-N.

The encapsulation matrix 505 can include graphite, silicon carbide (SiC), zirconium carbide (ZrC), magnesium oxide (MgO), tungsten (W), molybdenum (Mo), zirconium boride (ZrB₂), NbC, TiC, TaC, TiN, zirconium (Zr), TaC, B₄C, β-Si₃N₄, SiAlON ceramics, aluminum nitride (AlN), aluminum oxide (Al₂O₃), stainless steel, or a combination thereof. Encapsulation matrix 505 may be formed of silicon carbide (SiC), which has excellent chemical stability in the presence of air and water in repository conditions, but also at temperatures of a nuclear reactor core. If SiC is not sufficiently high performance, another high-temperature matrix material such as zirconium carbide (ZrC) can also be used.

The encapsulation matrix 505 can be formed of the same material as the binary carbide layer 106 of the interim fuel particles 100A-N. Interim fuel particles 100A-N are designed not to crack due to the stresses or fission gas pressure at temperatures beyond 1,600 °C, and therefore can contain the nuclear fuel in the worst of accident scenarios. Interim fuel particles 100A-N are designed for use in high-temperature gas-cooled reactors (HTGR) and to be operating at temperatures much higher than the temperatures of light water reactors. Interim fuel particles 100A-N have extremely low failure below 1,500 °C. Moreover, the presence of the encapsulation matrix 505 provides an additional robust barrier to radioactive product release.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” “has,” “having,” “containing,” “contain”, “contains,” “with,” “formed of,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element. Unless otherwise stated, the articles “a” or “an” preceding an element mean one or more of the elements.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±5% or as much as ±10% from the stated amount. The terms “approximately,” “significantly,” and “substantially” mean that the parameter value or the like varies up to ±10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

What is claimed is:

1. A method, comprising steps of:
forming a uranium carbide kernel;
depositing a protective carbon layer onto the uranium carbide kernel;
depositing an inner zirconium carbide layer onto the protective carbon layer;
depositing one or more coating layers around the inner zirconium carbide layer to fabricate an interim fuel particle; and
applying a high temperature heat treatment to the interim fuel particle to form a final fuel particle comprising a uranium zirconium carbide fuel kernel and the one or more coating layers.

2. The method of claim 1, wherein the one or more coating layers include a carbon buffer layer, an inner pyrolytic carbon layer, a zirconium carbide coating layer, and an optional outer pyrolytic carbon layer.

3. The method of claim 2, wherein the final fuel particle is comprised of the uranium zirconium carbide fuel kernel, the carbon buffer layer, the inner pyrolytic carbon layer, the zirconium carbide coating layer, and the optional outer pyrolytic carbon layer.

4. The method of claim 1, wherein the one or more coating layers are formed of pyrolytic carbon (PyC), silicon carbide (SiC), zirconium carbide (ZrC), zirconium diboride (ZrB₂), niobium carbide (NbC), titanium carbide (TiC), tantalum carbide (TaC), titanium nitride (TiN), boron carbide (B₄C), beta-decayed silicon nitride (β-Si₃N₄), SiAlON ceramics, or any combination thereof.

5. The method of claim 1, wherein the one or more coating layers include a carbon buffer layer, an inner pyrolytic carbon layer, a binary carbide layer, and an optional outer pyrolytic carbon layer around the inner zirconium carbide layer.

6. The method of claim 5, wherein the binary carbide layer includes a refractory metal carbide layer or a ceramic layer.

7. The method of claim 6, wherein the refractory metal carbide layer includes at least one of titanium carbide (TiC), zirconium carbide (ZrC), niobium carbide (NbC), tantalum carbide, hafnium carbide, ZrC—ZrB₂ composite, ZrC—ZrB₂—SiC composite, or a combination thereof.

8. The method of claim 7, wherein the refractory metal carbide layer includes zirconium carbide (ZrC).

9. The method of claim 6, wherein the ceramic layer includes silicon carbide.

10. The method of claim 1, wherein the inner zirconium carbide layer is at least twice as thick as the protective carbon layer.

11. The method of claim 1, wherein the high temperature heat treatment is a temperature of approximately 2,500 Kelvin or above.

12. The method of claim 1, wherein the high temperature heat treatment is applied to the interim fuel particle prior to deployment in a nuclear thermal propulsion (NTP) engine or a nuclear reactor.

13. The method of claim 1, wherein the high temperature heat treatment is applied in-situ to the interim fuel particle during operation of a nuclear thermal propulsion (NTP) engine or a nuclear reactor.

14. The method of claim 1, wherein the final fuel particle is a tristructural-isotropic (TRISO) fuel particle, a bistructural-isotropic (BISO) fuel particle, or a TRIZO fuel particle.

15. The method of claim 1, further comprising disposing the plurality of interim fuel particles inside an encapsulation matrix prior to the step of applying the high temperature heat treatment, wherein:
the step of applying the high temperature heat treatment is applied to the plurality of interim fuel particles inside the encapsulation matrix to form a plurality of final fuel particles comprising the uranium zirconium carbide fuel kernel and the one or more coating layers inside the encapsulation matrix; and
the encapsulation matrix includes graphite, silicon carbide (SiC), zirconium carbide (ZrC), magnesium oxide (MgO), tungsten (W), molybdenum (Mo), zirconium boride (ZrB₂), NbC, TiC, TaC, TiN, zirconium (Zr), TaC, B₄C, β-Si₃N₄, SiAlON ceramics, aluminum nitride (AlN), aluminum oxide (Al₂O₃), stainless steel, or a combination thereof.

16. A method, comprising steps of:
forming a uranium carbide kernel;
depositing a protective carbon layer onto the uranium carbide kernel;
depositing an inner zirconium carbide layer onto the protective carbon layer;
depositing a carbon buffer layer, an inner pyrolytic carbon layer, a zirconium carbide coating layer, and an outer pyrolytic carbon layer around the inner zirconium carbide layer to fabricate an interim fuel particle; and
applying a high temperature heat treatment to the interim fuel particle to form a final fuel particle comprising a uranium zirconium carbide fuel kernel, the carbon buffer layer, the inner pyrolytic carbon layer, the zirconium carbide coating layer, and the outer pyrolytic carbon layer.

17. The method of claim 16, wherein the high temperature heat treatment is at a temperature of approximately 2,500 Kelvin or above.

18. The method of claim 16, further comprising disposing the plurality of interim fuel particles inside an encapsulation matrix prior to the step of applying the high temperature heat treatment, wherein:
the step of applying the high temperature heat treatment is applied to the plurality of interim fuel particles inside the encapsulation matrix to form a plurality of final fuel particles comprising the uranium zirconium carbide fuel kernel, the carbon buffer layer, the inner pyrolytic carbon layer, the zirconium carbide coating layer, and the outer pyrolytic carbon layer inside the encapsulation matrix; and
the encapsulation matrix includes graphite, silicon carbide (SiC), zirconium carbide (ZrC), magnesium oxide (MgO), tungsten (W), molybdenum (Mo), zirconium boride (ZrB₂), NbC, TiC, TaC, TiN, zirconium (Zr), TaC, B₄C, β-Si₃N₄, SiAlON ceramics, aluminum nitride (AlN), aluminum oxide (Al₂O₃), stainless steel, or a combination thereof.

19. The method of claim 16, wherein the high temperature heat treatment is applied in-situ to the interim fuel particle during operation of a nuclear thermal propulsion (NTP) engine or a nuclear reactor.

20. The method of claim 16, wherein the plurality of final fuel particles include tristructural-isotropic (TRISO) fuel particles, bistructural-isotropic (BISO) fuel particles, or TRIZO fuel particles.
